(19) United States
(12) Patent Application Publication
(10) Pub. No.: US 2020/0302027 A1
(43) Pub. Date: Sep. 24, 2020

(54) SIMULATION METHOD AND SIMULATION DEVICE FOR SEMICONDUCTOR STORAGE DEVICE

(71) Applicant: Toshiba Memory Corporation, Minato-ku (JP)

(72) Inventor: Atsushi SAKAI, Kawasaki (JP)

(73) Assignee: Toshiba Memory Corporation, Minato-ku (JP)

(21) Appl. No.: 16/565,597

(22) Filed: Sep. 10, 2019

(30) Foreign Application Priority Data
Mar. 18, 2019 (JP) 2019-050498

(51) Int. Cl. G06F 17/50; G06F 11/07

(52) U.S. Cl. CPC G06F 17/5009; G06F 11/0772; G06F 11/0751; G06F 11/0727

(57) ABSTRACT

According to an embodiment, a simulation method of a simulation device that simulates a semiconductor storage device connected to a first controller via a first communication channel. The simulation method includes: receiving first data from a portion of the first communication channel; receiving second data from the portion; and simulating a response of the semiconductor storage device based on first information. The first data is data which has been transferred from the first controller to the semiconductor storage device and of which writing is requested from the first controller. The second data is data which has been stored in the semiconductor storage device, and transferred from the semiconductor storage device to the first controller, and of which reading is requested from the first controller. The first information indicates a feature of the semiconductor storage device obtained based on comparison between the first data and the second data.

### CROSS-REFERENCE TO RELATED APPLICATIONS

This application is based upon and claims the benefit of priority from Japanese Patent Application No. 2019-050498, filed on Mar. 18, 2019; the entire contents of which are incorporated herein by reference.

### FIELD

Embodiments described herein relate generally to a simulation method and simulation device for a semiconductor storage device.

### BACKGROUND

Conventionally, a test is performed to evaluate whether or not a controller that controls a semiconductor storage device operates according to the specification under actual use conditions at a stage of designing or manufacturing the controller. When a failure occurs in the controller in such a test, the controller is reformed, and then, confirmation on whether or not the failure has been resolved or the like is performed. At the time of confirming whether or not the failure has been resolved, it is required to reproduce a behavior when the failure has occurred by the semiconductor storage device.

### BRIEF DESCRIPTION OF THE DRAWINGS

FIG. 1 is a diagram illustrating an example when a simulation device of a first embodiment is used in a learning mode;

FIG. 2 is a diagram illustrating an example of a configuration of a memory chip in the first embodiment;

FIG. 3 is a circuit diagram illustrating a configuration example of one block included in a memory cell array in the first embodiment;

FIG. 4 is a diagram illustrating an example when the simulation device of the first embodiment is used in a simulation mode;

FIG. 5 is an exemplary and schematic diagram illustrating a specific configuration of the simulation device of the first embodiment;

FIG. 6 is an exemplary and schematic diagram illustrating an example of information stored in a storage device provided in the simulation device of the first embodiment;

FIG. 7 is a flowchart for explaining an example of a test method in the learning mode using the simulation device of the first embodiment;

FIG. 8 is a flowchart for explaining an example of a test method in the simulation mode using the simulation device of the first embodiment;

FIG. 9 is a diagram illustrating an example when a simulation device of a second embodiment is used in a learning mode;

FIG. 10 is an exemplary and schematic diagram illustrating information stored in a storage device provided in the simulation device of the second embodiment;

FIG. 11 is a diagram illustrating an example when the simulation device of the second embodiment is used in a simulation mode;

FIG. 12 is an exemplary and schematic diagram illustrating a specific configuration of the simulation device of the second embodiment;

FIG. 13 is a flowchart for explaining an example of a test method in the learning mode using the simulation device of the second embodiment; and

FIG. 14 is a flowchart for explaining an example of a test method in the simulation mode using the simulation device of the second embodiment.

### DETAILED DESCRIPTION

According to the present embodiment, a simulation method is a simulation method of a simulation device that simulates a semiconductor storage device connected to a first controller via a first communication channel. The simulation method includes: receiving first data from a portion of the first communication channel; receiving second data from the portion; and simulating a response of the semiconductor storage device based on first information. The first data is data which has been transferred from the first controller to the semiconductor storage device and of which writing is requested from the first controller. The second data is data which has been stored in the semiconductor storage device, and transferred from the semiconductor storage device to the first controller, and of which reading is requested from the first controller. The first information indicates a feature of the semiconductor storage device obtained based on comparison between the first data and the second data.

Hereinafter, the simulation method and the simulation device for the semiconductor storage device according to embodiments will be described in detail with reference to the attached drawings. Incidentally, the present invention is not limited to these embodiments.

### First Embodiment

A simulation device according to a first embodiment can operate in two modes of a learning mode of learning a feature of a semiconductor storage device and a simulation mode of simulating a behavior of the semiconductor storage device based on the learned feature.

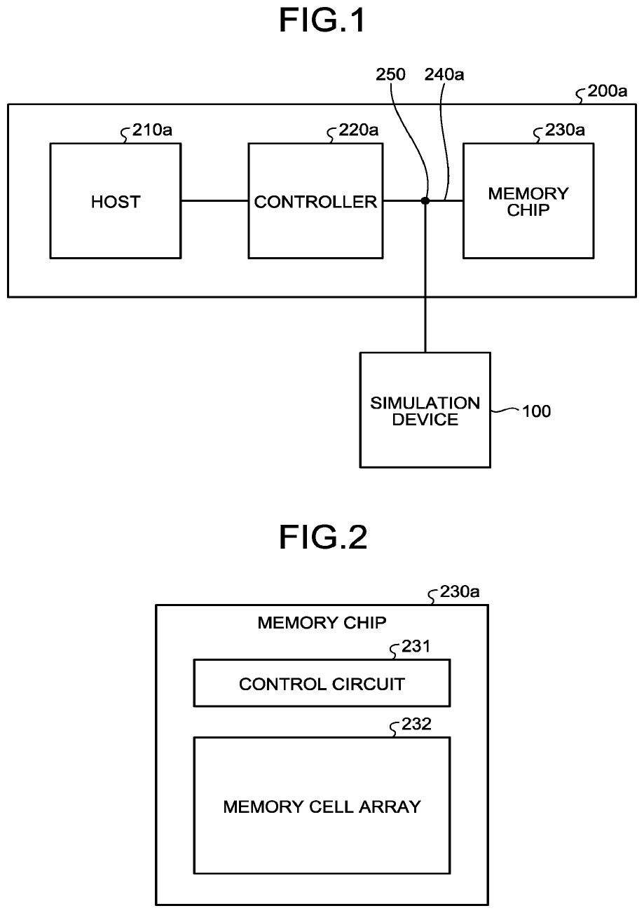

FIG. 1 is a diagram illustrating an example when a simulation device of a first embodiment is used in a learning mode. As illustrated in FIG. 1, a host 210a, a controller 220a, and a memory chip 230a constitute a test device 200a configured to evaluate whether or not the controller 220a operates according to the specification even under actual use conditions.

Here, the memory chip 230a is assumed to be a memory chip of a NAND flash memory as an example. Incidentally, the memory chip 230a is an example of the semiconductor storage device.

The controller 220a and the memory chip 230a are connected by a communication channel 240a. The communication channel 240a is an example of a first communication channel.

The communication channel 240a comprises a wiring group including an IO signal line and a control signal line. The 10 signal line is a signal line configured to transmit and receive data, an address, and a command. The control signal line is, for example, a signal line configured to transmit and receive a chip enable (CE) signal, a write enable (WE) signal, a read enable (RE) signal, a command latch enable (CLE) signal, an address latch enable (ALE) signal, a write protect (WP) signal, a data strobe (DQS) signal, a ready/busy (Ry/By) signal, and the like.

The controller 220a is an electronic component that can constitute a memory system together with the memory chip 230a. The controller 220a may be configured using a hardware circuit or may include a processor that executes a program such as firmware. Further, the controller 220a may also include a storage device such as a register, a flip-flop, and a memory. The controller 220a can execute access to the memory chip 230a in the memory system based on a request from an external device of the memory system. Examples of the external device include a server computer, a personal computer, a central processing unit (CPU), a portable information terminal, and the like. Examples of the request include a request for storing data, a request for reading data, and a request for erasing data. Incidentally, the controller 220a is an example of a first controller.

The host 210a operates as the external device. That is, the host 210a can transmit various requests to the controller 220a. Here, the host 210a sequentially transmits the requests to the controller 220a according to a procedure prepared in advance to test the operation of the controller 220a. The procedure is described in, for example, a program. The host 210a is, for example, a processor, and transmits the requests to the controller 220a according to the procedure described in the program. Incidentally, the host 210a may be configured using a hardware circuit that does not require a program.

The controller 220a executes access to the memory chip 230a based on a request from the host 210a or the like. Specifically, the access by the controller 220a includes transmission of a write command for writing data to the memory chip 230a together with the data, transmission of a read command for reading data from the memory chip 230a, and reception of data output in response to the read command from the memory chip 230a. The write command and the read command include an address (physical address) indicating an access destination.

Hereinafter, data transferred from the controller 220a to the memory chip 230a will be referred to as write data in some cases. Further, data transferred from the memory chip 230a to the controller 220a will be referred to as read data in some cases.

FIG. 2 is a diagram illustrating an example of a configuration of the memory chip 230a in the first embodiment. The memory chip 230a includes a control circuit 231 and a memory cell array 232. The control circuit 231 executes access to memory cell array 232 based on a command from controller 220a. The access to the memory cell array 232 includes a program process of programming data into a memory cell MT, a read process of reading the data programmed in the memory cell MT, and an erase process of erasing the data programmed in the memory cell MT.

The memory cell array 232 includes a plurality of blocks. Pieces of data stored in the respective blocks are collectively erased. Each of the blocks includes a plurality of pages. Each of the pages is the minimum unit in which the program process or the read process is performed.

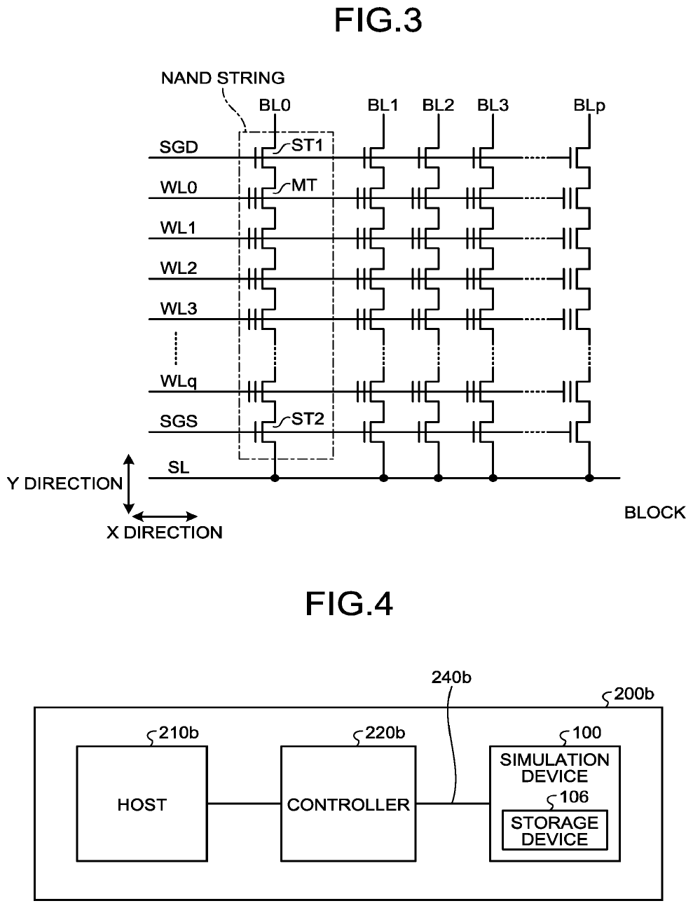

FIG. 3 is a circuit diagram illustrating a configuration example of one block included in the memory cell array 232 in the first embodiment. As illustrated in FIG. 3, each block includes (p+1) NAND strings arrayed in order along the X direction (p≥0). Select transistors ST1 included in the (p+1) NAND strings have drains connected to the bit lines BL0 to BLp, respectively, and gates commonly connected to a select gate line SGD. Further, selection transistors ST2 have sources commonly connected to a source line SL, and gates commonly connected to a select gate line SGS.

Each of the memory cells MT is configured using a metal oxide semiconductor field effect transistor (MOSFET) having a stacked gate structure formed on a semiconductor substrate. The stacked gate structure includes a floating gate formed on the semiconductor substrate with a tunnel oxide film interposed therebetween, and a control gate electrode formed above the floating gate with an inter-gate insulating film interposed therebetween. A threshold voltage changes depending on the number of electrons stored in the floating gate. The memory cell MT stores data depending on a difference in threshold voltage. That is, the memory cell MT holds electric charges, the number of which corresponds to the data, in the floating gate.

In each NAND string, (q+1) memory cells MT are arranged such that current paths thereof are connected in series between the source of the select transistor ST1 and the drain of the select transistor ST2. Then, the control gate electrodes are connected to word lines WL0 to WLq in order from the memory cell MT positioned closest to the drain side. Therefore, a drain of the memory cell MT connected to the word line WL0 is connected to the source of the select transistor ST1, and a source of the memory cell MT connected to the word line WLq is connected to the drain of the select transistor ST2.

Each of the word lines WL0 to WLq connect the control gate electrodes of the memory cells MT in common between the NAND strings inside the block. That is, the control gate electrodes of the memory cells MT in the same row inside the block are connected to the same word line WL. When each of the memory cells MT is configured to be capable of holding a 1-bit value, (p+1) memory cells MT connected to the same word line WL are handled as one page, and the program process and the read process are performed for each of the pages.

Incidentally, each of the memory cells MT can store data of a plurality of bits. For example, when each of the memory cells MT can store data of n (n≥2) bits, a storage capacity per word line is equal to the size of n pages.

The control circuit 231 sets a threshold voltage of the memory cell MT of a page to be programmed to a level corresponding to data in the program process. Further, in the read process, the control circuit 231 compares the threshold voltage of the memory cell MT of the page to be read with a predetermined determination voltage to decode the level of the threshold voltage to data. Further, in the erase process, the control circuit 231 sets threshold voltages of all the memory cells MT included in a block to be erased to a predetermined level corresponding to an erased state.

The description will be given with reference to FIG. 1 again. The threshold voltage of each of the memory cells MT may vary due to various factors. Therefore, there may occur an error in which a data value, different from a data value programmed in a memory cell MT, is read from the memory cell MT. The data value garbled by the error is detected in the controller 220a, and corrected to a correct data value.

That is, the controller 220a has an error detection and correction function of detecting and correcting an error included in read data. The controller 220a performs encoding for error correction on data, and transmits the encoded data as write data to the memory chip 230a. Further, when the controller 220a receives read data, the controller 220a decodes the read data to execute detection and correction of an error included in the read data. If the error correction is successful, the controller 220a can acquire data in the same state as that of the data before being subjected to encoding.

Incidentally, the controller 220a can execute a refresh process, a wear leveling process, or a garbage collection process in addition to the operation in response to the request from the host 210a although the detailed description thereof is omitted here. The controller 220a autonomously executes these processes without the request from the host 210a. Even in these processes, the controller 220a can execute access to the memory chip 230a.

In the first embodiment, the communication channel 240a is provided with a branch portion 250 that divides the communication channel 240a. A branch destination generated by the branch portion 250 is connected to a simulation device 100. Accordingly, the simulation device 100 can receive various signals, transferred between the controller 220a and the memory chip 230a, via the branch portion 250. In the learning mode, the simulation device 100 can learn features of the memory chip 230a based on the various signals transferred between the controller 220a and the memory chip 230a.

The features include a feature relating to an error. In the first embodiment, an error rate and an error pattern are regarded as the features as an example.

The error rate is a ratio between the number of pieces of normal bit data or the number of pieces of bit data constituting unit data and the number of pieces of bit data garbled by an error. The unit data is, for example, data of a page size. Incidentally, the definition of the error rate is not limited thereto. Any quantity may be defined as the error rate as long as the quantity corresponds to a ratio or the amount of bit data garbled by an error included in data of a predetermined size.

The error pattern is information indicating an appearance tendency of an error. In one example, the error pattern indicates a portion of a word line where an error is likely to occur.

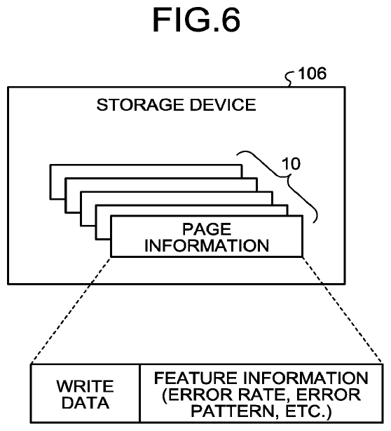

The learned feature is recorded as feature information (see FIG. 6). After the feature information is obtained, the simulation device 100 may be used in the simulation mode.

FIG. 4 is a diagram illustrating an example when the simulation device 100 of the first embodiment is used in the simulation mode. As illustrated in FIG. 4, a host 210b, a controller 220b, and the simulation device 100 constitute a test device 200b configured to evaluate whether or not the controller 220b operates according to the specification even under actual use conditions.

The host 210b performs the same operation as that of the host 210a. The controller 220b may be the same as the controller 220a or may be a controller different from the controller 220a. The controller 220b may be a controller that has been reformed to cope with a failure that has occurred. The controller 220b is an example of a second controller.

The controller 220b and the simulation device 100 are connected by a communication channel 240b. The communication channel 240b is an example of a second communication channel.

The communication channel 240b is configured using the same wiring group as that of the communication channel 240a. That is, for example, the communication channel 240b includes an IC signal line and a control signal line. The control signal line is, for example, a signal line configured to transmit and receive a CE signal, a WE signal, a RE signal, a CLE signal, an ALE signal, a WP signal, a DQS signal, a Ry/By signal, and the like.

In the simulation mode, the simulation device 100 performs an operation simulating a behavior of the memory chip 230a according to the feature information. For example, when receiving a write command from the controller 220b, the simulation device 100 stores write data, which has been transmitted together with the write command, in a storage device 106 provided therein. Thereafter, when receiving a read command, which requests reading of the write data already stored in the storage device 106, from the controller 220b, the simulation device 100 reads the write data from the storage device 106, process the read write data based on the feature information, and transmits the processed write data to the controller 220b as read data.

Here, the processing is generating an error in data in one example. That is, the simulation device 100 generates an error in data, received as write data from the controller 220b, and outputs the data including the error as read data. The error is generated in accordance with the learned feature of the memory chip 230a. Thus, the simulation device 100 can operate as a pseudo memory chip having the same feature as that of the memory chip 230a.

Incidentally, a method of the processing is not limited to the above method. The simulation device 100 can perform various types of processing on write data and transmit the processed write data as read data.

According to a technique to be compared with the embodiment, when a failure occurs in a controller during a test, a retest is executed to elucidate the failure or to confirm that the reformed controller has resolved the failure. Here, even in a case where a plurality of memory chips are manufactured in the same manufacturing process, features vary among the plurality of memory chips due to manufacturing variations and the like. In order to equalize conditions relating to the features of the memory chips between the case of a test where a failure has occurred and the case of a retest, the memory chip used in the test where the failure has occurs is used in the retest. Therefore, when it is desired to execute the retest a plurality of times, the total time required for the retests becomes longer according to the number of retests. Hereinafter, the technique to be compared with the embodiment will be referred to as a technique according to a comparative example.

In the first embodiment, the simulation device 100 learns the feature of the memory chip 230a in the learning mode, and operates as the pseudo memory chip having the same feature as that of the memory chip 230a in the simulation mode. Accordingly, if the simulation device 100 is used in the learning mode in the first test and the simulation device 100 is used in the simulation mode when a failure occurs in the controller 220a, it is possible to eliminate the need for the memory chip 230a in the retest.

Further, for example, if a plurality of the simulation devices 100 are prepared and the same feature information is set to each of the plurality of simulation devices 100, all of the plurality of simulation devices 100 operate as pseudo memory chips having the same feature as that of the memory chip 230a. That is, when each of the plurality of simulation devices 100 is connected to each of a plurality of test devices 100b and used, it is possible to execute a plurality of retests in parallel. As a result, it is possible to significantly reduce the total time required for the retest as compared with the technique according to the comparative example.

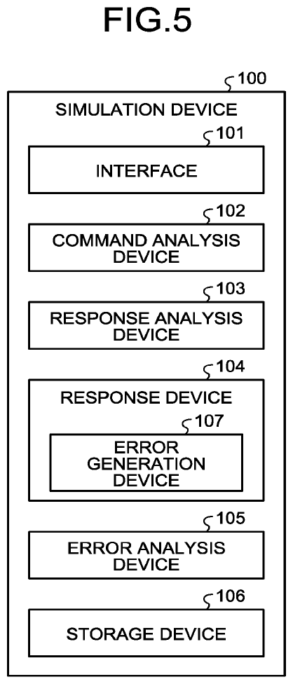

Subsequently, a specific configuration of the simulation device 100 according to the first embodiment will be described. FIG. 5 is an exemplary and schematic diagram illustrating a specific configuration of the simulation device 100 of the first embodiment.

The simulation device 100 includes an interface 101, a command analysis device 102, a response analysis device 103, a response device 104, an error analysis device 105, and a storage device 106. The response device 104 includes an error generation device 107. The interface 101, the command analysis device 102, the response analysis device 103, the response device 104, and the error analysis device 105 are examples of a processing device.

Some or all of the command analysis device 102, the response analysis device 103, the response device 104, and the error analysis device 105 may be configured using a hardware circuit that does not require a program or may be configured using a processor that operates based on a program. Further, some or all of the devices (the interface 101, the command analysis device 102, the response analysis device 103, the response device 104, the error analysis device 105, and the storage device 106) provided in the simulation device 100 may be configured using a field-programmable gate array (FPGA) or an application specific integrated circuit (ASIC).

The interface 101 is hardware configured for connection to the communication channel 240a and the communication channel 240b. The interface 101 may include a physical terminal and a buffer that receives a signal.

The command analysis device 102 is a device that analyzes signals output by the controller 220a and the controller 220b. The command analysis device 102 can extract at least a write command, a read command, a physical address, and write data from the signals output by the controller 220a and the controller 220b.

The response analysis device 103 is a device that analyzes a signal output from the memory chip 230a in the learning mode. The response analysis device 103 can extract at least read data from the signal output from the memory chip 230a.

The response device 104 can generate a response to a command from the controller 220b and transmit the generated response to the controller 220b in the simulation mode.

When the response device 104 transmits data corresponding to read data to the controller 220b, the error generation device 107 generates an error in the data. As a result, the response device 104 can transmit the data including the generated error to the controller 220b as the read data.

The error analysis device 105 receives feature information based on comparison between write data and read data in the learning mode. That is, the error analysis device 105 specifies a data bit different between the write data and the read data as an error, and calculates an error rate and an error pattern based on the number and a position of the specified error. Then, the error analysis device 105 records the calculated error rate and error pattern as the feature information.

The storage device 106 is configured using a register, a static random access memory (SRAM), a dynamic access memory (DRAM), a flash memory, a hard disk drive, or a combination thereof. The storage device 106 stores write data, feature information, and the like.

FIG. 6 is an exemplary and schematic diagram illustrating an example of information stored in the storage device 106 provided in the simulation device 100 of the first embodiment. The storage device 106 stores page information 10 corresponding to each of all the pages included in the memory cell array 232.

One piece of the page information 10 includes write data written to the corresponding page and feature information regarding the corresponding page. That is, the feature information is calculated and recorded for each page according to this example. The feature information includes the error rate and the error pattern as described above.

Incidentally, the feature information may include arbitrary information in addition to the error rate and the error pattern. For example, the feature information may include voltage information, temperature information, a storage mode, time information, and the like. The voltage information is, for example, a voltage value used by the control circuit 231 during access (the program process or the read process) to the corresponding page, such as a determination voltage for determining the threshold voltage of the memory cell MT. The temperature information is temperature of peripheral environment of the memory chip 230a or the memory chip 230a during the access (the program process or the read process) to the corresponding page. The storage mode is information indicating the amount of data to be stored in one memory cell MT. The time information is information indicating the time when the access (the program process or the read process) to the corresponding page has been executed.

Further, a data configuration of a group of the page information 10 is not limited to a specific configuration. For example, the group of page information 10 may constitute one table or may constitute one list. Further, the page information 10 for all the pages is not necessarily stored in the storage device 106. For example, the page information 10 regarding a page to which write data is not written is not necessarily stored in the storage device 106 in the learning mode. Further, the page information 10 regarding a page for which read has not been performed and thus acquisition of feature information has failed is not necessarily stored in the storage device 106 in the learning mode.

Further, in each of pieces of the page information 10, write data may be recorded in an overwrite format or write data may be added in a log format whenever the program process is performed on the corresponding page. Similarly, the feature information may be recorded in overwrite format or may be added in a log format whenever access to the corresponding page is executed.

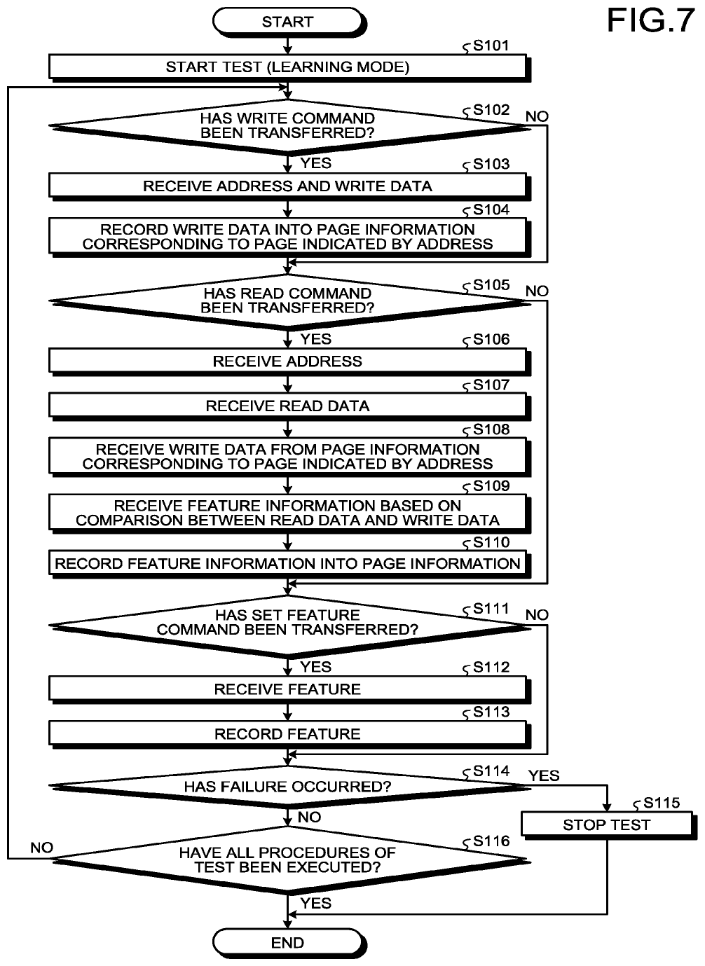

Subsequently, a series of operations using the simulation device 100 of the first embodiment will be described. FIG. 7 is a flowchart for explaining an example of a test method in the learning mode using the simulation device 100 of the first embodiment.

When the simulation device 100 is used in the learning mode, the simulation device 100 is connected to the branch portion 250 provided in the communication channel 240a that connects the controller 220a and the memory chip 230a as illustrated in FIG. 1.

Then, when a test is started (S101), the host 210a sends various requests to the controller 220a in a predetermined procedure, and the controller 220a accesses the memory chip 230a based on the request. Further, the controller 220a executes a refresh process, a wear leveling process, a garbage collection process, and the like, and autonomously accesses the memory chip 230a during these processes.

In the simulation device 100, the interface 101 receives a signal transferred between the controller 220a and the memory chip 230a via the branch portion 250. Then, the command analysis device 102 and the response analysis device 103 analyze a signal received by the interface 101.

For example, when the write command has been transferred (S102: Yes), the command analysis device 102 detects the write command, and receives a physical address and write data transferred through the communication channel 240a together with the write command (S103). Then, the command analysis device 102 records the received write data in the page information 10 corresponding to a page indicated by the received address (S104).

The command analysis device 102 may record arbitrary information when recording the write data. For example, the command analysis device 102 may receive temperature information using a temperature sensor (not illustrated), and record the received temperature information as a part of feature information. Further, when recording the write data, the command analysis device 102 may receive time information from a timer (not illustrated) and record the received time information as a part of feature information.

Moreover, when not a write command but a read command has been transferred (S102: No, and S105: Yes), the command analysis device 102 detects the read command and receives a physical address transferred together with the read command (S106). Further, the response analysis device 103 receives read data, transferred from the memory chip 230a to the controller 220a, in response to the transferred read command (S107).

Subsequently, the error analysis device 105 receives write data from the page information 10 regarding a page indicated by the address received by the process of S106 (S108). Then, the error analysis device 105 receives feature information based on comparison between the read data received by the process of S107 and the write data received by the process of S108 (S109). That is, the error analysis device 105 calculates an error rate and an error pattern in S109. The error analysis device 105 records the feature information received by calculation in the page information 10 regarding the page indicated by the address received by the process of S106 (S110).

Incidentally, the error analysis device 105 may record arbitrary information at the time of acquiring the read data. For example, the error analysis device 105 may receive temperature information using a temperature sensor (not illustrated), and record the received temperature information as a part of the feature information. Further, when the read data has been received, the error analysis device 105 may receive time information from a timer (not illustrated) and record the received time information as a part of the feature information.

In this manner, when the write command has been transferred, the simulation device 100 operating in the learning mode receives the write data and stores the received write data into the storage device 106 during the test. Further, when the read command has been transferred, the simulation device 100 receives the read data, receives the feature information based on the comparison between the write data stored in the storage device 106 and the read data, and records the received feature information. As these operations are repeatedly executed, the write data is written, and then, feature information regarding all pages from which the data has been read is accumulated in the storage device 106. That is, the features of the memory chip 230a are learned.

When a set feature command has been transferred instead of a write command and a read command (S102: No, S105: No, and S111: Yes), the command analysis device 102 detects the set feature command and receives a feature set by the set feature command (S112). Then, the command analysis device 102 records the received feature into the storage device 106 (S113).

The set feature command is a command to set various features to a memory chip. For example, a determination voltage can be set by the set feature command.

The read command includes a read command to perform read using a standard determination voltage, and a read command to perform read using the determination voltage set by the set feature command. In general, the read using the standard determination voltage is performed, but a search for a determination voltage to correctly read data is performed when an error rate of data inside a block BLK becomes low. A voltage value of the determination voltage obtained by the search is set by the set feature command, and read of data inside the corresponding block is executed using the determination voltage set by the set feature command.

When a set value of the determination voltage has been transferred by the set feature command, the command analysis device 102 records the set value into the storage device 106. The set value of the determination voltage is recorded, for example, in association with the block BLK.

There is a case where a failure occurs in the controller 220a during the test. For example, after S113 or after it is determined as No in the determination process of S111, it is determined whether or not a failure has occurred in the controller 220a (S114). If the failure has occur in the controller 220a (S114: Yes), the test is stopped (S115). Then, the test using the simulation device 100 in the learning mode ends. For example, when detecting that the controller 220a does not execute an intended operation, the host 210a can determine that a failure has occurred and stop the test. Incidentally, a method of detecting the occurrence of the failure and a method of stopping the test are not limited to the above methods. An arbitrary device can detect the occurrence of the failure and stop the test in an arbitrary method.

Further, when the host 210a finishes a series of procedures for the test without causing a failure in the controller 220a (S114: No, and S116: Yes), the test using the simulation device 100 in the learning mode ends. If there still remains a procedure (S116: No), the control shifts to S102.

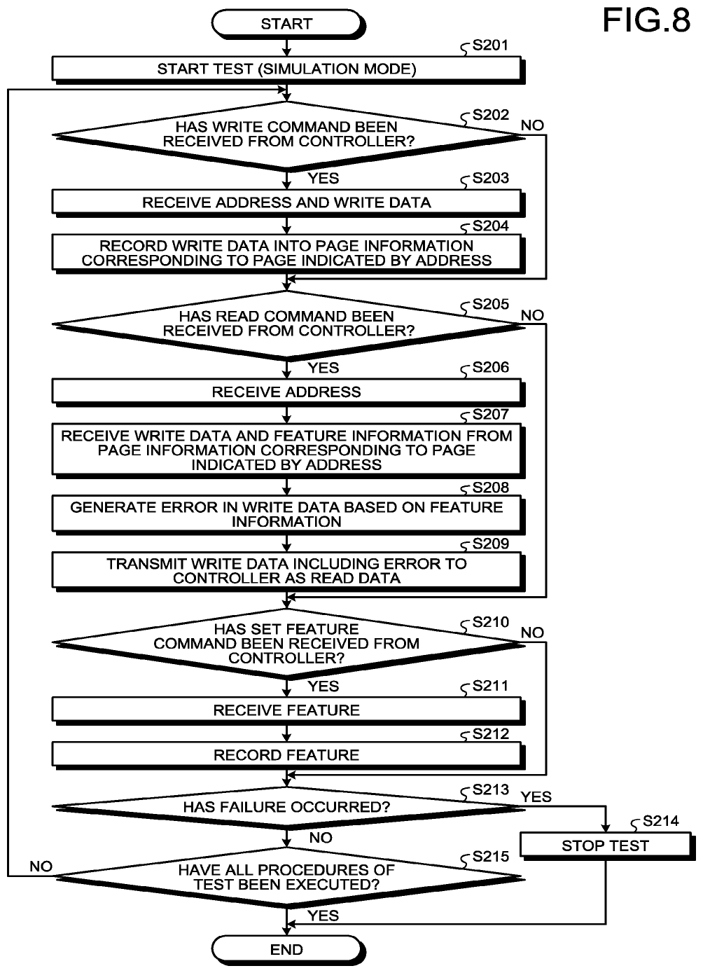

FIG. 8 is a flowchart for explaining an example of a test method in the simulation mode using the simulation device 100 of the first embodiment.

When the simulation device 100 is used in the simulation mode, the simulation device 100 is connected to the controller 220b via the communication channel 240b as illustrated in FIG. 4. When a test is started (S201), the host 210b sends various requests to the controller 220b according to a predetermined procedure similarly to the host 210a in the learning mode. The controller 220b regards the simulation device 100 as a memory chip and executes access to the simulation device 100. That is, the controller 220b transmits various commands to the simulation device 100 and receives various responses from the simulation device 100. Further, the controller 220b executes a refresh process, a wear leveling process, a garbage collection process, and the like, and autonomously accesses the simulation device 100 even in these processes.

In the simulation device 100, the interface 101 receives a signal transmitted from the controller 220b. Then, the command analysis device 102 and the response analysis device 103 analyze the signal received by the interface 101.

For example, when the write command has been received (S202: Yes), the command analysis device 102 detects the write command, and receives a physical address and write data transferred through the communication channel 240b together with the write command (S203). Then, the command analysis device 102 records the received write data into the page information 10 corresponding to a page indicated by the received address (S204).

Moreover, when not a write command but a read command has been received (S202: No and S205: Yes), the command analysis device 102 detects the read command and receives a physical address transferred together with the read command (S206). Then, the response device 104 receives the write data and feature information from the page information 10 regarding a page indicated by the address received by the process of S206 (S207).

The error generation device 107 generates an error in the write data based on the feature information (S208). For example, the error generation device 107 bit-inverts the pieces of bit data, the number of which corresponds to an error rate out of a string of pieces of bit data of the write data. A position of bit data to be bit-inverted is set to a position based on an error pattern. As a result, data whose feature regarding an error is similar to the feature of the read data output from the memory chip 230a in the learning mode is generated.

The response device 104 transmits the write data including the error to the controller 220b as read data (S209). As a result, a response simulating a behavior of the memory chip 230a is executed. Incidentally, the transmission of read data is executed via the interface 101.

Further, when the set feature command is received instead of a write command and a read command (S202: No, S205: No, and S210: Yes), the command analysis device 102 detects the set feature command and receives a feature set by the set feature command, that is, a set value of a determination voltage (S211). Then, the command analysis device 102 records the received feature, that is, the set value of the determination voltage into the storage device 106 (S212). When responding to a read command received thereafter, read data corresponding to the determination voltage set by the set feature command is output.

For example, after S212 or after it is determined as No in the determination process of S210, it is determined whether or not a failure has occurred in the controller 220b (S213). If the failure has occur in the controller 220b (S213: Yes), the test is stopped (S214). Then, the test using the simulation device 100 in the simulation mode ends. For example, when detecting that the controller 220b does not execute an intended operation, the host 210b can determine that a failure has occurred and stop the test. Incidentally, a method of detecting the occurrence of the failure and a method of stopping the test are not limited to the above methods. An arbitrary device can detect the occurrence of the failure and stop the test in an arbitrary method.

Further, when the host 210b finishes a series of procedures for the test without causing a failure in the controller 220b (S213: No, and S215: Yes), the test using the simulation device 100 in the simulation mode ends. If there still remains a procedure (S215: No), the control shifts, to S202, for example.

Incidentally, the description has been given regarding the example in which the simulation device 100 operates in the learning mode to receive the feature information and store the received feature information into the storage device 106, and then, simulates the behavior of the memory chip 230a using the feature information stored in the storage device 106 at the time of operating in the simulation mode, in the description of FIGS. 7 and 8. The simulation device 100 operating in the simulation mode may be a device different from the simulation device 100 operating in the learning mode. For example, when a copy of the feature information received by the simulation device 100 operating in the learning mode is stored in the storage device 106 of the simulation device 100 operating in the simulation mode, the simulation device 100 operating in the simulation mode can simulate the behavior of the memory chip 230a.

Further, a plurality of the simulation devices 100 operating in the simulation mode may be provided. The plurality of simulation devices 100 operating in the simulation mode can respectively simulate the behavior of the memory chip 230a, and thus, can execute a plurality of tests in parallel.

Further, the simulation device 100 according to the first embodiment may be constituted by a first device operating only in the learning mode and a second device operating only in the simulation mode. In such a case, the first device can be configured such that the response device 104 is eliminated from the configuration of the simulation device 100 illustrated in FIG. 5. Further, the second device can be configured such that the response analysis device 103 is eliminated from the configuration of the simulation device 100 illustrated in FIG. 5.

Further, the description has been given assuming that the feature information is recorded for each page in the above description. The feature information may be recorded for each unit different from the page. For example, the feature information may be recorded for each block.

Incidentally, when the feature information is recorded for each block, for example, the feature information may be received in an arbitrary method. In one example, a representative page is set in advance for each block, and feature information regarding the representative page is regarded as feature information of a block including the representative page. In another example, for each block, feature information of a page for which read was executed last is regarded as feature information of a block including the page.

In this manner, the simulation device 100 receives the write data, which is transferred from the controller 220a to the memory chip 230a and of which writing is requested from the controller 220a, from the branch portion 250 provided in the communication channel 240a that connects the controller 220a and the memory chip 230a according to the first embodiment. Thereafter, the simulation device 100 receives the read data that is write data which is transferred from the memory chip 230a to the controller 220a and of which reading is requested from the controller 220a, from the branch portion 250. Then, the simulation device 100 receives the feature information indicating the feature of the memory chip 230a based on the comparison between the write data and the read data. The simulation device 100 simulates the response of the memory chip 230a based on the feature information. With the above configuration, it is possible to simulate the behavior of the memory chip 230a.

Further, the feature information includes the information on the error according to the first embodiment. With the above configuration, the simulation device 100 can respond to the read data having the same feature as that of the read data output from the memory chip 230a in terms of the error.

Further, the simulation device 100 receives the write data of which writing is requested from the controller 220b via the communication channel 240b that connects the controller 220b and the simulation device 100 according to the first embodiment. The simulation device 100 stores the received write data into the storage device 106. Then, the simulation device 100 reads the write data from the storage device 106 in response to the command to read the write data, that is, the read command and processes the write data based on the feature information. Then, the simulation device 100 transmits the processed write data as the read data to the controller 220b via the communication channel 240b. With the above configuration, it is possible to simulate the behavior of the memory chip 230a.

Further, the feature information includes the information on the error according to the first embodiment. The simulation device 100 generates the error in the write data based on the information on the error recorded as the feature information. With the above configuration, the simulation device 100 can output data having the same feature as that of the read data output from the memory chip 230a in terms of the error in response to the read command.

Further, the memory chip 230a includes the plurality of pages, and the simulation device 100 receives the feature information for each page according to the first embodiment.

Incidentally, the simulation device 100 may be configured to receive the feature information for each unit different from the page. For example, the simulation device 100 may receive the feature information for each block.

### Second Embodiment

When a procedure of a test executed by a host includes a plurality of processes, there is a case where an operator desires to re-execute the test from an arbitrary timing of the plurality of processes. In a second embodiment, the simulation device 100, which enables re-execution of a test from an arbitrary timing, will be described.

Hereinafter, the simulation device 100 according to the second embodiment is referred to as a simulation device 100a. The same components as those in the first embodiment among components included in the simulation device 100a will be denoted by the same names and reference signs as those of the first embodiment. Then, the same components as those of the first embodiment will not be described or will be briefly described.

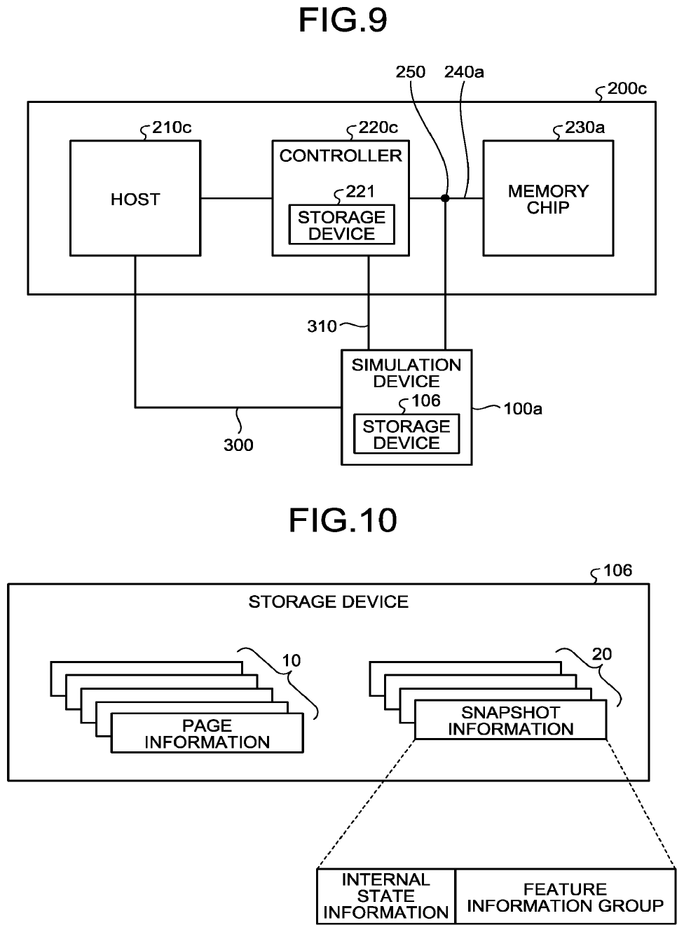

FIG. 9 is a diagram illustrating an example when the simulation device 100a of the second embodiment is used in a learning mode. A host 210c, a controller 220c, and the memory chip 230a constitute a test device 200c configured to evaluate whether or not the controller 220c operates according to the specification even under actual use conditions.

The controller 220c is an electronic component that can constitute a memory system together with the memory chip 230a. The controller 220c can perform, for example, the same operation as that of the controller 220a. The controller 220c is another example of the first controller.

The controller 220c is connected to the memory chip 230a via the communication channel 240a. The branch portion 250 that divides the communication channel 240a is provided. A branch destination generated by the branch portion 250 is connected to a simulation device 100a. Accordingly, the simulation device 100a can receive various signals, transferred between the controller 220c and the memory chip 230a, via the branch portion 250. In the learning mode, the simulation device 100a can learn features of the memory chip 230a based on the various signals transferred between the controller 220c and the memory chip 230a.

The simulation device 100a is further connected to the host 210c via a communication channel 300. Further, the simulation device 100a is connected to the controller 220c via a communication channel 310. The communication channel 300 is an example of a third communication channel.

The host 210c operates as an external device with respect to the memory system. That is, the host 210c can transmit various requests to the controller 220c similarly to the host 210a. Here, the host 210c sequentially transmits the requests to the controller 220c according to a procedure set in advance to test the operation of the controller 220c. The procedure is described using, for example, a program. The host 210c is, for example, a processor, and transmits the requests to the controller 220c according to the procedure described using the program. Incidentally, the host 210c may be configured using a hardware circuit that does not require a program.

Further, the host 210c can transmit a snapshot instruction to the simulation device 100a via the communication channel 300 once or more at different timings. For example, if the test procedure includes a plurality of processes to be executed consecutively, the host 210c can transmit the snapshot instruction to the simulation device 100a whenever each process is completed. Incidentally, the timing to transmit the snapshot instruction is not limited thereto. The snapshot instruction is an example of a first instruction.

When receiving the snapshot instruction, the simulation device 100a stores feature information and internal state information of the controller 220c in the storage device 106 provided therein.

Here, the internal state information of the controller 220c is information indicating a state of the storage device 221 provided in the controller 220c. The storage device provided in the controller 220c includes a register, a flip-flop, and a memory. When the controller 220c includes a processor, the storage device provided in the controller 220c includes a register in the processor. The simulation device 100a receives content of the storage device 221 as the internal state information via the communication channel 310, and stores the received internal state information into the storage device 106 in association with the feature information (feature information group) of all pages. Such a pair of the internal state information and the feature information group is referred to as snapshot information.

FIG. 10 is an exemplary and schematic diagram illustrating information stored in the storage device 106 provided in the simulation device 100a of the second embodiment. The storage device 106 stores the page information 10 corresponding to each of all the pages included in the memory cell array 232, and one or more pieces of snapshot information 20.

Each of the one or more pieces of snapshot information 20 is stored in response to the snapshot instruction, and is constituted by a pair of internal state information and a feature information group. The internal state information included in the snapshot information 20 is the internal state information received in response to the reception of the snapshot instruction. The feature information group is feature information for all pages collected from all pieces of the page information 10 in response to the reception of the snapshot instruction.

Incidentally, each of pieces of the snapshot information 20 may include information to specify each of pieces of the snapshot information 20 such as time information indicating a generated or stored time. Each of pieces of the snapshot information 20 may include an ID as the information to specify each of pieces of the snapshot information 20. The ID may be designated from the host 210c by the snapshot instruction or may be generated by the simulation device 100a. The ID may be a process number designated by the host 210c. The process number is, for example, a unique number assigned to each of the plurality of processes included in the test procedure.

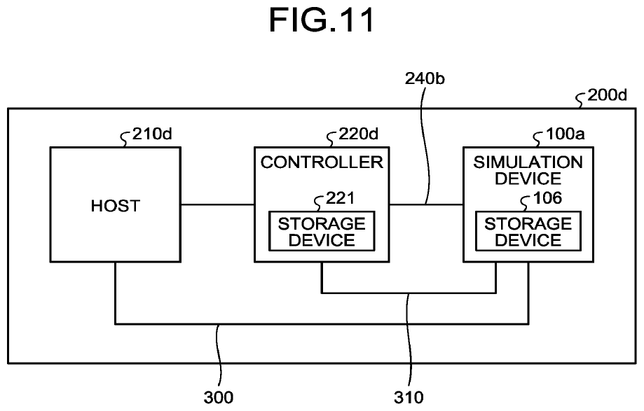

FIG. 11 is a diagram illustrating an example when the simulation device 100a of the second embodiment is used in a simulation mode. As illustrated in FIG. 11, a host 210d, a controller 220d, and the simulation device 100a constitute a test device 200d configured to evaluate whether or not the controller 220d operates according to the specification even under actual use conditions.

The host 210d performs the same operation as that of the host 210c. The controller 220d may be the same as the controller 220c or may be a controller different from the controller 220c. The controller 220d may be a controller that has been reformed to cope with a failure that has occurred. The controller 220d is an example of the second controller.

The controller 220d and the simulation device 100a are connected via the communication channel 240b. The simulation device 100a is connected to the host 210d via the communication channel 300. Further, the simulation device 100a is connected to the controller 220d via the communication channel 310.

When operating in the simulation mode, the simulation device 100a can receive an instruction to specify one piece of the snapshot information 20 from the host 210d. This instruction is referred to as a designation instruction. The designation instruction is an example of a second instruction. The simulation device 100a receives the designation instruction via the communication channel 300.

Incidentally, a data structure of the designation instruction may be arbitrarily configured. Examples of the designation instruction may include an ID, time information, a process number, and the like.

The simulation device 100a loads a feature information group included in the designated snapshot information 20 among the one or more pieces of snapshot information 20 stored in the storage device 106. That is, the simulation device 100a records each of pieces of the feature information of all the pages included in the feature information group into the corresponding page information 10. As a result, the simulation device 100a can start an operation simulating the feature of the memory chip 230a at a time when the designated snapshot information 20 has been generated.

Further, the simulation device 100a sets the internal state information included in the designated snapshot information 20 in the controller 220d. That is, the simulation device 100a overwrites a storage device 2221, such as a register, a flip-flop, and a memory, provided in the controller 220d with the internal state information. As a result, the controller 220d can start the same operation as that of the controller 220c at the time when the designated snapshot information 20 has been generated.

As the feature information group is loaded and the internal state information is set, the controller 220d and the simulation device 100a can start the test from the time when the designated snapshot information 20 has been generated. The host 210d starts a test from the time when the designated snapshot information 20 has been generated in the test procedure.

When the test is started, the simulation device 100a performs an operation simulating the behavior of the memory chip 230a according to the feature information included in the page information 10. For example, when receiving a write command from the controller 220d, the simulation device 100a stores write data, which has been transmitted together with the write command, in a storage device 106 provided therein. Thereafter, when receiving a read command from the controller 220d, the simulation device 100a reads write data stored in the storage device 106, process the read write data based on the feature information included in the page information 10, and transmits the processed write data to the controller 220d as read data.

In this manner, the simulation device 100a generates the snapshot information 20 at the instructed timing in the learning mode. The snapshot information 20 includes the feature information group in which pieces of the feature information of all the pages are collected and the internal state information of the controller 220c. Then, the simulation device 100a is configured to be capable of designating any one out of the one or more pieces of snapshot information 20 generated at different timings in the simulation mode. As a result, if the host 210c transmits the snapshot instruction at a point when it is desired to execute a test again later, the simulation device 100a can start the test from such a point. That is, it is possible to execute the test again from an arbitrary timing.

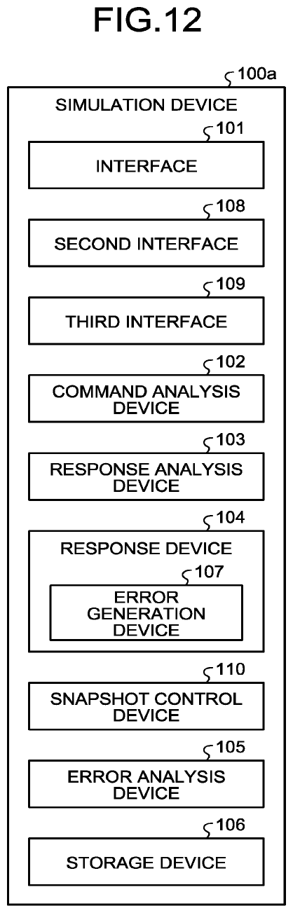

Subsequently, a specific configuration of the simulation device 100a of the second embodiment will be described. FIG. 12 is an exemplary and schematic diagram illustrating a specific configuration of the simulation device 100a of the second embodiment.

The simulation device 100a includes the interface 101, the command analysis device 102, the response analysis device 103, the response device 104, the error analysis device 105, and the storage device 106. The response device 104 includes an error generation device 107.

The simulation device 100a further includes a second interface 108, a third interface 109, and a snapshot control device 110.

The interface 101, the command analysis device 102, the response analysis device 103, the response device 104, the error analysis device 105, the second interface 108, the third interface 109, and the snapshot control device 110 constitute another example of the processing device.

The second interface 108 is hardware configured for connection to the communication channel 300. The second interface 108 may include a physical unit and a buffer that receives a signal.

The third interface 109 is hardware configured for connection to the communication channel 310. The third interface 109 may include a physical unit and a buffer that receives a signal.

The snapshot control device 110 can generate the snapshot information 20 in response to a snapshot instruction and store the snapshot information 20 into the storage device 106. Further, the snapshot control device 110 can receive internal state information and a feature information group from the snapshot information 20 designated by the designation instruction to set the internal state information in the controller 220d and load the feature information group.

Incidentally, the snapshot control device 110 may be configured using a hardware circuit that does not require a program or may be configured using a processor that operates based on a program, which is similar to the command analysis device 102, the response analysis device 103, the response device 104, the error analysis device 105, and the like. Further, the snapshot control device 110 may be configured using an FPGA or an ASIC.

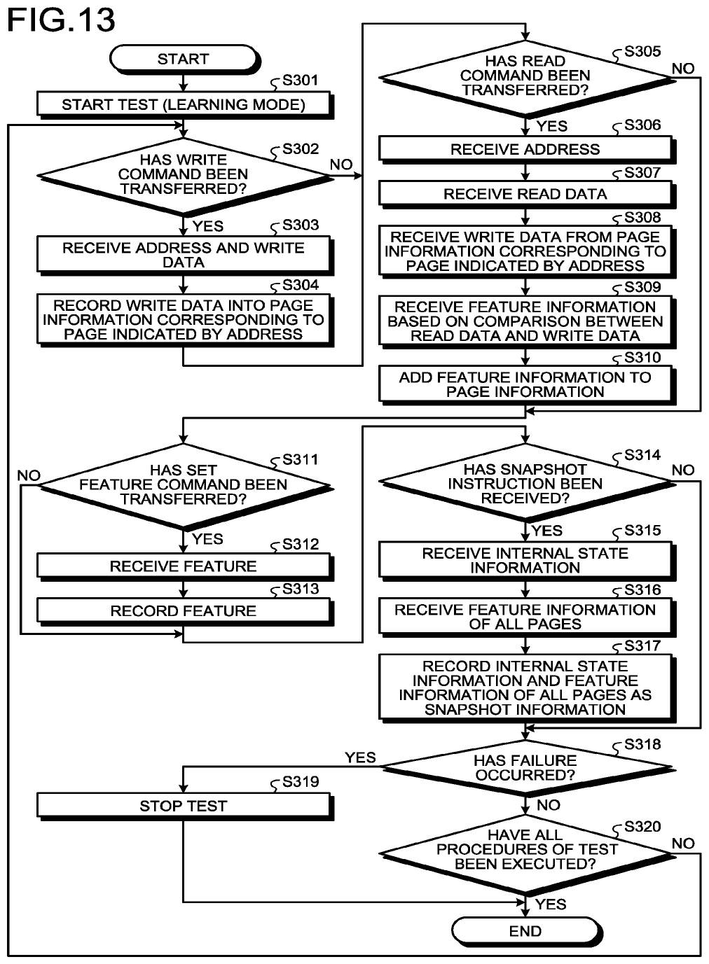

Subsequently, a series of operations using the simulation device 100a of the second embodiment will be described. FIG. 13 is a flowchart explaining an example of a test method in the learning mode using the simulation device 100a of the second embodiment.

When the simulation device 100a is used in the learning mode, the simulation device 100a is connected to the branch portion 250 provided in the communication channel 240a that connects the controller 220c and the memory chip 230a as illustrated in FIG. 9. Further, the simulation device 100a is connected to the host 210c via the communication channel 300. Further, the simulation device 100a is connected to the controller 220c via the communication channel 310.

Then, when a test is started (S301), the same processes as those in S102 to S113 of FIG. 7 are performed in S302 to S313.

During the test, when the simulation device 100a receives a snapshot instruction (S314: Yes), the snapshot control device 110 receives internal state information of the controller 220c via the communication channel 310 (S315). Further, the snapshot control device 110 receives feature information from the entire page information 10 (S316). That is, the snapshot control device 110 receives the feature information of all the pages.

Then, the snapshot control device 110 records the internal state information received by the process of S315 and the feature information of all the pages received by the process of S316 as the snapshot information 20 (S317).

Incidentally, when the snapshot instruction has not been received (S314: No), the processes of S315 to S317 are skipped.

Thereafter, the same processes as those in S114 to S116 of FIG. 7 are performed in S318 to S320.

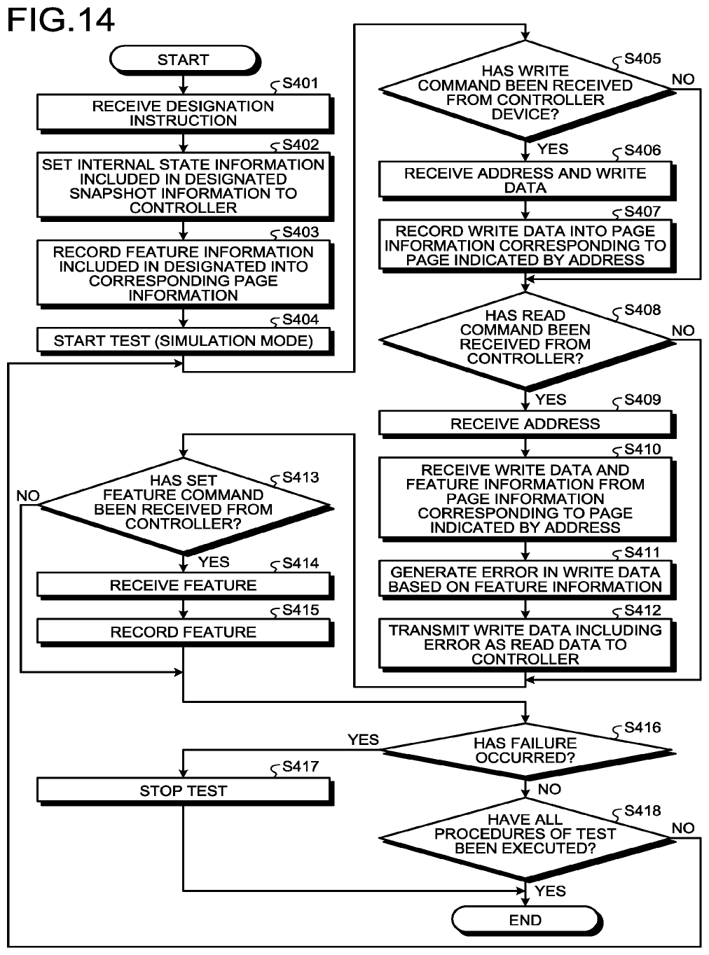

FIG. 14 is a flowchart explaining an example of a test method in the simulation mode using the simulation device 100a of the second embodiment.

When the simulation device 100a is used in the simulation mode, the simulation device 100a is connected directly to the controller 220d via the communication channel 240b as illustrated in FIG. 11. Further, the simulation device 100a is connected to the host 210d via the communication channel 300. Further, the simulation device 100a is connected to the controller 220d via the communication channel 310.

Then, before starting a test, the simulation device 100a receives a designation instruction from the host 210d via the communication channel 300 (S401). Then, the snapshot control device 110 sets internal state information included in the snapshot information 20 designated by the designation instruction in the controller 220d (S402). Further, the snapshot control device 110 records a feature information group, included in the snapshot information 20 designated by the designation instruction, into the page information 10 (S403). That is, the snapshot control device 110 records each of pieces of the feature information of all the pages included in the feature information group into the corresponding page information 10.

Thereafter, when the test is started (S404), the same processes as those in S202 to S215 of FIG. 8 are performed in S405 to S418. Incidentally, during the test, the host 210d can start the test from a point in the test procedure at which the designated snapshot information 20 has been generated.

In this manner, the controller 220c is connected to the host 210c and transmits a command to the memory chip 230a based on a request from the host 210c according to the second embodiment. The simulation device 100a receives the snapshot instruction from the host 210c via the communication channel 300 that connects the simulation device 100a and the host 210c. The simulation device 100a receives the internal state information of controller 220c in response to the snapshot instruction and stores the snapshot information 20 including the internal state information and the feature information group into the storage device 106. Further, the simulation device 100a sets the internal state information included in the snapshot information 20 in the controller 220d and loads the feature information group included in the snapshot information 20 before starting the test in the simulation mode.

With the above configuration, it is possible to execute the test again from an arbitrary point in a series of procedures of the test.

Further, the process of generating the snapshot information 20 and storing the generated snapshot information 20 in the storage device 106 can be executed a plurality of times according to the second embodiment. Then, the simulation device 100a can receive a designation instruction to designate one of the plurality of pieces of snapshot information 20 stored in the storage device 106 from the host 210d.

With the above configuration, it is possible to execute the test again from an arbitrary point among a plurality of points in the series of procedures of the test.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A simulation method of a simulation device for simulating a semiconductor storage device, the semiconductor storage device being connected to a first controller via a first communication channel, the simulation method comprising:
receiving first data, which is transferred from the first controller to the semiconductor storage device and of which writing is requested from the first controller, from a portion of the first communication channel;
receiving second data, which is stored in the semiconductor storage device and transferred from the semiconductor storage device to the first controller and of which reading is requested from the first controller, from the portion; and
simulating a response of the semiconductor storage device based on first information indicating a feature of the semiconductor storage device obtained based on comparison between the first data and the second data.

2. The simulation method according to claim 1, wherein
the first information includes information on an error in the second data.

3. The simulation method according to claim 1, wherein
the simulating includes:
receiving third data of which writing is requested from a second controller via a second communication channel connecting the second controller and the simulation device;
storing the received third data into a memory provided in the simulation device;
reading the stored third data from the memory in response to a command to read the third data from the second controller, processing the read third data based on the first information, and transmitting fourth data which is the processed third data to the second controller via the second communication channel.

4. The simulation method according to claim 3, wherein
the first controller is further configured to be connected to a host and transmit a command to the semiconductor storage device based on a request from the host,
the simulation method further comprising:
receiving a first instruction from the host via a third communication channel connecting the simulation device and the host;
receiving second information indicating an internal state of the first controller in response to the received first instruction and storing snapshot information including the first information and the received second information into the memory; and
before starting the simulating, setting the second information included in the snapshot information to the second controller and loading the first information included in the snapshot information.

5. The simulation method according to claim 4, wherein
the storing the snapshot information is executed a plurality of times at different timings, and
the setting the second information and loading the first information includes receiving a second instruction to designate one of a plurality of pieces of the snapshot information stored in the memory from the host.

6. The simulation method according to claim 3, wherein
the first information includes information on an error of the second data, and
the transmitting the fourth data include generating an error in the third data based on the information on the error.

7. The simulation method according to claim 1, wherein
the semiconductor storage device includes a plurality of storage areas, and
the simulation method further comprising
storing into a memory provided in the simulation device the first information in association with a storage area in which the first data has been stored among the plurality of storage areas.

8. A simulation device comprising:
an interface that is connectable to a first communication channel connecting a first controller and a semiconductor storage device; and
a processing device configured to;
receive first data, which is transferred from the first controller to the semiconductor storage device and of which writing is requested from the first controller, via the interface,
receive second data, which is stored in the semiconductor storage device and transferred from the semiconductor storage device to the first controller and of which reading is requested from the first controller, via the interface, and
simulate a response of the semiconductor storage device based on first information indicating a feature of the semiconductor storage device obtained based on comparison between the first data and the second data.

9. The simulation device according to claim 8, wherein
the first information includes information on an error in the second data.

10. The simulation device according to claim 8, further comprising
a memory,
wherein the processing device is further configured to;
receive third data, of which writing is requested from a second controller, via a second communication channel connecting the second controller and the simulation device,
store the received third data in the memory, and
read the stored third data from the memory in response to a command to read the third data from the second controller, process the read third data based on the first information, and transmit fourth data which is the processed third data to the second controller via the second communication channel.

11. The simulation device according to claim 10, wherein
the first controller is further configured to be connected to a host and transmit a command to the semiconductor storage device based on a request from the host, and
the processing device is further configured to;
receive a first instruction from the host via a third communication channel connecting the simulation device and the host,
receive second information indicating an internal state of the first controller in response to the received first instruction and store snapshot information including the first information and the received second information into the memory, and
before starting the simulating, set the second information included in the snapshot information to the second controller and load the first information included in the snapshot information.

12. The simulation device according to claim 11, wherein
the processing device is further configured to;
receive a plurality of the first instructions at different timings,
generate the snapshot information and store the generated snapshot information in the memory whenever each of the plurality of first instructions is received, and
receive a second instruction to designate one of a plurality of pieces of the snapshot information stored in the memory from the host.

13. The simulation device according to claim 10, wherein
the first information includes information on an error of the second data, and
the processing device is further configured to;
generate an error in the third data based on the information on the error.

14. The simulation device according to claim 8, further comprising
a memory,
wherein the semiconductor storage device includes a plurality of storage areas, and
the processing device is further configured to; store into the memory the first information in association with a storage area in which the first data has been stored among the plurality of storage areas.
